(19) United States
(12) Patent Application Publication
(10) Pub. No.: US 2011/0104347 A1
(43) Pub. Date: May 5, 2011

(54) Preparing Formulations for Treating Agricultural Products

(76) Inventor: Dale Nelson, Wisconsin Rapids, WI (US)

(21) Appl. No.: 13/005,197

(22) Filed: Jan. 12, 2011

Related U.S. Application Data
(62) Division of application No. 12/123,254, filed on May 19, 2008, now abandoned.
(60) Provisional application No. 61/027,837, filed on Feb. 12, 2008.

(51) Int. Cl. A23L 3/34; A01N 47/10

(52) U.S. Cl. 426/321; 504/143

(57) ABSTRACT

The invention provides an improved method for creating a formulation using a solid chemical agent in solution within a reservoir, and treating crops within a storage facility with an aerosol of the solution substantially at the time of use. The method includes having a premixing section for formulating the solution and mixing solid with a solvent in a premixing section. Further the solution may be heated by circulating it through a substantially instantaneous heater then channeling the solution into a commercial fogger, generating an aerosol of the CIPC solution, and providing said storage facility with said aerosol.

### RELATED APPLICATIONS

The present application is a divisional continuation under 37 CFR 1.53(b) of U.S. application Ser. No. 12/123,254; filed 19 May 2008, which is also dependent from U.S. provisional application Ser. No. 61/027,837 filed 12 Feb. 2008, both applications incorporated by reference herein and for which benefit of the priority date is hereby claimed.

### FIELD OF THE INVENTION

The present invention relates to an apparatus and method for preparing formulations, for treating agricultural products. More particularly, for making formulations substantially at the time of use, with a substantially solid chemical agent. Uses include making formulations having a solid chemical agent for treating produce for diseases, or for sprout inhibitor solutions comprising; Carbamate, substituted Naphthalene, and in particular N-substituted esters of carbamic acid, such as Chlorpropham commonly known as CIPC, by mixing with solutions comprising oils, surfactants and solvents, which are commonly used to treat produce storage facilities, typically as an aerosol.

### BACKGROUND OF THE INVENTION

Carbamate chemistries have been used to treat a number of agricultural products for years. Carbamates are N-substituted esters of carbamic acid. Their

general formula is R¹NH-ester-OR² where R² is an aromatic or abrimhatic moiety. Three main classes of carbamate chemistries are generally found:

carbamate insecticides; R¹ is a methyl group;

carbamate herbicides; R¹ is an aromatic moiety; and

carbamate fungicides; R¹ is a benzimidazole moiety.

Depending upon desired use pattern, these chemistries can be applied as a solid (generally granules), dust-able powder, or liquid formulations. This disclosure is primarily directed at preparing liquid formulations, and particularly directed at potato sprout inhibition. In a broader sense, formulations of this type can be used for a wider variety of applications such as; growth regulation in control of weeds in alfalfa, beans, blueberries, cane berries, carrots, cranberries, ladino clover, garlic, onions, spinach, sugar beets, tomatoes, safflower, soybeans, gladioli, and woody nursery stock. It is also used to inhibit potato sprouting and for sucker control in tobacco.

Potatoes are typically stored in facilities under proper conditions to maintain quality which can include inhibit sprouting, because sprouting reduces, if not ruins, the value of the potato for marketability. Chemical sprout inhibitors need to be more effective in retard potato sprouting despite the most carefully controlled storage conditions. The classes of Carbamate chemistries, such as Chlorpropham, and Naphthalene chemistries, including substituted Naphthalene chemistries, have been found to be effective at suppressing sprout formation. One of the most effective sprout inhibitors used on potatoes during storage is isopropyl-N-chlorophenylcarbamate, or CIPC. CIPC is typically applied as an aerosol, or fog type suspension comprising suspended particles typically between 1 to 5 micrometers in diameter, but can be applied as an emulsion, and is known to inhibit sprout growth because it interferes with spindle formation during cell division.

Solvents are used in specific formulations allow agricultural products to be applied as aerosols or stable fogs. U.S. Pat. No. 2,460,792 by Pabst, discloses a method of application using a pre-mixed solution DDT and treatment chemicals from an airplane through a fogger to obtain a stable aerosol. Due to the time required to dissolve the solute and methods of application, the Pabst methodology required essentially pre-made solutions, which create a problem for hazardous materials storage and spills.

U.S. Pat. No. 3,128,170 by Plant, discloses a method for applying solutions of N-3-chlorophenylcarbamate within a potato storage facility with a water based solvent, preferably propylene glycol, and creating an aerosol via a pair of coaxially mounted high speed rotating discs. The method disclosed creates liquid globules of 1 to 10 microns in diameter, which are suspended in a circulating gas stream through the stored potatoes.

U.S. Pat. No. 4,226,179 by Sheldon was the first to disclose use of CIPC in molten form, without solvent, with a preferred embodiment being a solution with 60% to 75% solvent. The methodology discloses ultrasonically atomizing CIPC as his invention. Sheldon recognized an optimal range of particle sizes is desired in a CIPC aerosol to maximize effectiveness. Sheldon teaches that solvents are desired to reduce the normally high viscosity of CIPC to avoid solidification in the sump (pump) and can be atomized into small aerosol particles. A major drawback of the Sheldon method being a complex and relatively large application apparatus with ultrasonic atomizing nozzles.

Sheldon teaches a fogger containing ultrasonic atomizing nozzles, a cyclone chamber, a scrubber and conduits; that when combined made the fogger difficult to transport and use.

Sheldon also indicates that the CIPC is subject to chemical decomposition when exposed to, or stored at, temperatures above 250° F. This finding is further confirmed by Cooperative Extension Offices such as EXTOXNET which reports decomposition at temperatures as low as 150° C. (300° F.). Sheldon further reports; “A major disadvantage of use of the thermal fogger, however, is that it heats the CIPC to temperatures in the range of 700° F. to 900° F., and above . . . . In fact, the predominant compound found in chromatographic analysis of a (typical high temperature) thermal fogger-produced mist was not CIPC but M-chloro aniline. Additional breakdown products were produced, some of which are as yet unidentified by ordinary gas chromatographic methods. The result of the thermal fog-producing process (at such high application temperatures) is decomposition of up to 80% of the sprout inhibiting chemical; that is, of the portion of the resultant fog which can be identified as CIPC of products of its decomposition, as little as 20% is CIPC.” EXTOXNET further confirms that high temperature “Thermal decomposition may release highly toxic fumes of phosgene, toxic and corrosive fumes of chlorides, and oxides of carbon.”

U.S. Pat. Nos. 5,935,660 and 6,068,888 by Forsythe et. al., discloses a treatment of potato storage facilities with aerosols derived from molten CIPC. Forsythe teaches utilizing solid CIPC in a molten liquid “made with a purity of greater than 98% chemically pure CIPC” without using any solvent. The CIPC is melted by contact with a heating element and collected in a reservoir at a temperature greater than 150° F. to attend to problems with flow-ability of the molten substance. The liquid CIPC is then pumped into a device through a heated conduit and into a thermal fogger. Their desired embodiment includes running a combustion thermal fogger “at temperatures of about 750° F.” with an “exit air temperature of at least about 550° F. is desired while exit air temperatures of about 600° F. to 650° F. are especially desirable”; with a pressure of at least 150 psig into the thermal fogger used to apply the aerosol into a potato storage shed.

There are several problems with using pure molten CIPC as a treatment. One being related to the high temperatures required to maintain the molten liquid which can easily solidify in equipment if not kept at temperatures above 105° F. during application. In operation, a heated zone is needed in the reservoir (12) as shown in the '660 patent, FIG. 2, where heating elements (11) are located in the in the reservoir (12) in addition to a heating element (13) to maintain the temperature “preferably above 125° F. and generally at temperatures of about 150° F. or higher to maintain optimum fluidity”. The requirement of a heated reservoir places a constraint on the design of the system.

Another problem being that even when molten, the liquid has a high viscosity which can be problematic to nozzles and pumps. This is particularly problematic when batch processes are used. When the piping cools down between batches, the CIPC solidifies in the pipe requiring piping to be preheated prior to subsequent applications to re-melt the CIPC in the pipe. This limitation required the Forsythe patent to further require a heated conduit for enablement of their invention as molten 98% pure (technical grade) CIPC will solidify below 105° F. In fact the '660 patent reported problems with; “temperatures which approaching 105° F. (liquid CIPC) is a more viscous material, which is more difficult to pump and may slow down the throughput.” (Col. 8 line 10 et seq.)

Not only are problems encountered with the temperatures required to keep the molten CIPC from solidifying inside the piping, but another issue being the extreme temperatures required for generation of a suitable aerosol or fog according to the Forsythe methodology. The high temperatures needed to create a thermal aerosol from molten CIPC can cause, not only a degeneration of the CIPC as previously mentioned, but also a potential safety hazard by the high temperature gasses expelled by the fogging apparatus.

In the past, those choosing an alternative to the problems caused by molten solid CIPC applications, may have chosen to use a premixed formulation, which also has drawbacks. Premade CIPC formulations were supplied in containers that are quite problematic to dispose of. According to MSDS requirements, such as required by Zelam Limited, read; “Triple rinse container and add residue to spray tank. Burn the container if circumstances, especially wind direction, permit. Otherwise bury in a landfill. Avoid contamination of any water supply with chemical or empty container. Do not use the container for any other purpose.”

The existing need in the art requires; mobility, ease of use, simple design, greater control and added efficiency.

While prior art discloses methods of preparing and applying premixed CIPC solutions using complex and cumbersome means, the present disclosure allows for a more lightweight system that is easy to use and transport, quick and simple to prepare on site, and safer to use. In addition, the formulation can be adjusted during the period of application using the disclosed methodology. The solid ingredients can be provided in blocks, pellets, shavings, or other discreet forms, which can be easily stored in solid form before application, then added to the reactor vessel as needed during application.

Those skilled in the art of produce treatment will recognize the improvements for using a less complex, fast, easy, and lightweight system to formulate a more effective treatment solution suitable for a variety of commercial applications.

### SUMMARY OF THE INVENTION

In accordance with the present invention, there is provided, in one aspect, an improved method for creating a formulation for treatment of produce with a chemical agent, such as a sprout inhibitor solution, within a reservoir substantially at the time of application, and treating the produce within a storage facility with an aerosol of the solution. The method comprising such steps as: having a reservoir of solvent, mixing a solid chemical agent, using a dissolution tray in such a way that the solid is dissolved by the solvent, storing the solution in a reservoir, then channeling the solution as required into an aerosol generator such as commercial fogger, generating an aerosol of the solution, and providing the aerosol to the storage facility.

The formulation is prepared by dissolving the solid chemical ingredient, for example solid CIPC, which initially may be powdered, pelletized, granular or in a block, in a dissolution tray so that a substantially saturated solution is made. The solvent is typically an inert polar solvent such as propylene glycol, clove oil or other suitable carrier base. Typical ratios of solvent to solute can range from 3% to 50% by weight.

It is preferred that a block form of the active chemical agent be used to aid in ease of transport, and reduce risk of waste and spillage of; liquids, powders or grains. The block, which in the case of a technical grade CIPC for example, has the approximate consistency of paraffin wax, is easily broken up and added to the formulation chamber at the time of use as will be shown later. Further, keeping the active ingredient in a solid form until the time of use keeps it more stable.

It is preferred that the solvent be heated shortly before mixing with the solid chemical agent to kinetically aid the dissolution process. Heating the solvent can also raise the solubility levels of the ingredient and volatility of the formulation, aiding in stable aerosol creation. Once dissolved, the formulation can be maintained at a controlled elevated temperature by circulating it through a heating element. While a range of elevated temperatures can be used, typically a temperature range between 80° F. to 200° F. is suitable with 180° F. being preferred for CIPC in a clove oil based solvent for example. It is left to those skilled in the art to determine optimum temperature and conditions for the various combinations of solid chemical agent(s) and solvent(s).

The formulation in combination with any solution can be circulated through a heater using a pump until a desired temperature and concentration of the formulation are achieved before application. It has been found that using a heated solvent at the time of application to dissolve the solid chemical agent decreases the setup time and labor by approximately 30% or more over prior methods. It has also been found that, even with the added matter from the solvent, the chemical application rate of active ingredient remains approximately the same as when using a molten pure CIPC. This is believed to be due to the increase in fugacity and decrease in viscosity created by the solvent in combination with the solid chemical agent over the solid chemical agent alone. Using this method in a typical application of 2,500 tons storage, an average improvement of 1.5 hours time saving can be seen per job, with corresponding labor and a BTU improvements.

In a preferred embodiment, the ingredient is suspended within the tank using a dissolution tray; such as a shelf, strainer, filter or similar means, to hold the solid ingredient and provide a platform for the addition of solvent supplied into the tray to facilitate the dissolution of the solids. The dissolution tray averts solids, which would otherwise be mixed in the main body of the solution, from clogging the collector drain at the bottom of the storage tank or piping. This creates a much more free flowing system than the current common method, as it does not have the constraints of the viscous, crystallizing, solidifying, molten solids. It further eliminates the need for a heated reservoir and heated piping for enablement.

The collector drain may lead to a pipe with a pair of valves: a circulating valve directing the flow towards a heater; and a discharge valve for directing flow towards a fogging apparatus or other applicator.

During mixture of the formulation, the feeder valve can remain closed while the re-circulating valve remains open to minimize the time required to bring the solution to temperature. This creates a closed system where the solution is pumped through the circulating valve, the heater, and back towards the reservoir.

Further, one skilled in the art can appreciate; the method can be controlled such that the ratio of the formulation can change during an application period as desired or required the specific needs of the application. For example the amount of solvent in the formulation chamber can be raised near the end of an application to assure that solid chemical agent concentrations are low such that no solid chemical agent precipitates out of solution into the piping as it cools.

In another example, using a thermal fogger, the consistency of the fog can be monitored during operation and; the ratio of solvent to solid chemical agent monitored along with temperature and feed rates can now be monitored real time and adjusted to maximize stability of aerosol, and size of particles for a given set of conditions.

In yet another example, CIPC can exist in a saturated solution at a given temperature. During an application cycle, temperatures and concentrations can be manipulated, to drive concentrations above solid solubility levels causing portions of the CIPC in solution to be precipitated out as crystals which are suspended in the formulation much like a colloidal suspension. This can allow one skilled in the art to create a formulation rich in suspended crystals. Such a formulation can create advantageous aerosol properties.

The heater may be a tankless heater of the type that uses heat exchange coils to avoid the need of pre-heating large reservoirs of solvent. Heating sources can be; natural gas, electricity, or propane etc. and can come from a wide variety of manufacturers such as Rheem, Bosch, Richmond or other manufacturers.

Once the desired formulation and temperature are reached, the re-circulating valve can be closed, if desired, through the re-circulating valve controller and the feeder valve is opened, by means of the feeder valve control, the formulation is supplied to the fogging apparatus.

It has been found that a plate temperature in the range of 350° F.-525° F. is sufficient to vaporize a CIPC solution, for example, and create a stable thermal fog when supplied by the formulation. A preferred temperature at the plate being approximately 425° F. to 450° F. This is highly preferable to the higher temperatures required to vaporize a substantially pure molten CIPC and further reduces the potential for decomposition of the CIPC which is a concern. Further, the lower temperatures required for vaporization results in a lower temperature of aerosol coming from the gun. A typical range of temperature into the plenum is 300° F. to 320° F. Exit temperatures in this range allows the use of flexible tubing, such as dryer conduit for example, to move the aerosol from the thermal fogger into the storage unit. This too results in a cost savings in not requiring high temperature materials. As the dryer vent material is depleted it can be disposed of in a safe manor. Further, the lower temperature stable fog adds much less thermal energy into a storage facility which is generally kept at temperatures of approximately 42° F.

It would be advantageous to provide a method for quickly and easily combining a solid active chemical with solvent to create a useful formulation on site at the time and point of use.

It would also be advantageous to provide a method for keeping the solid active chemical in solid form until time of use to avoid hazardous chemical spills.

It would further be advantageous to provide a treatment derived from a dissolved solid chemical agent which will not solidify in piping between applications.

It would further be advantageous to provide a method for reducing set up time for an application.

It would further be advantageous to provide a method for reducing the thermal fogging temperatures while maintaining good aerosol characteristics.

It would further be advantageous to provide a low energy alternative to molten CIPC.

It would further be advantageous to provide a method for adjusting the ratio of dissolved chemical agent to solvent during the application period.

It would further be advantageous to provide a portable apparatus to be carried on the back of a pickup truck or small trailer.

It would further be advantageous to provide an apparatus to be used with a variety of fogging devices.

It would further be advantageous to provide a methodology having reduced application temperatures for lower decomposition rates.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a schematic view of an apparatus used to create a liquid chemical agent formulation;

FIG. 2 is a schematic view of an alternate embodiment of an apparatus used to create a liquid chemical agent formulation;

FIG. 3 is a front perspective view of a formulation chamber with application apparatus;

FIG. 4 is a front perspective view of a preprocessor;

FIG. 5 is a top perspective view of a mill;

FIG. 6 is a side partial through view of a mill;

FIG. 7 is a frontal perspective view of a formulation chamber with a partial cutaway illustrating one arrangement for a dissolution tray with a dispenser;

FIG. 8 is a top perspective view into a formulation chamber showing an embodiment of a dissolution tray as in FIG. 8 showing a representation of solid chemical agent.

For purposes of clarity and brevity, like elements and components will bear the same designations and numbering throughout the Figures.

### DESCRIPTION OF THE PREFERRED EMBODIMENT

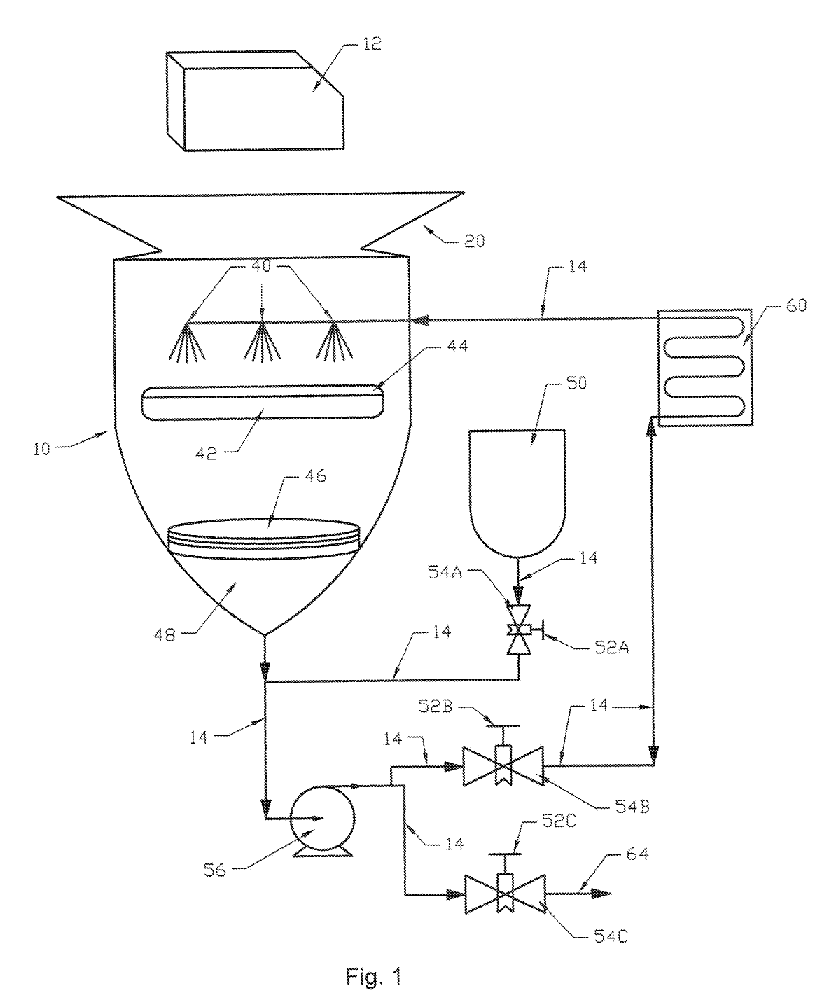

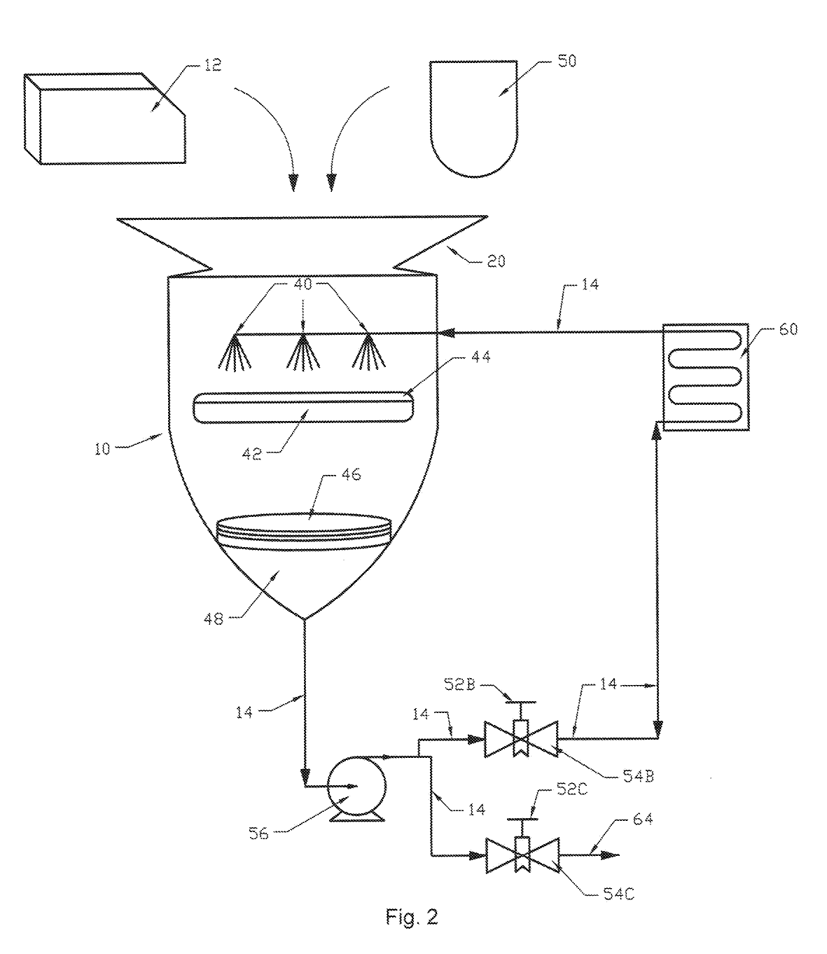

FIGS. 1, 2, and 3, depict variations having a preferred embodiment of an apparatus used to create a formulation for treating produce, typically in a storage situation. However, one skilled in the art can appreciate the multitude of other situations where the method can be used. A solid chemical agent (12) is added to the formulation chamber (10), typically through a preprocessor (20), which will be discussed in more detail hereafter. The formulation chamber (10) is typically made of a durable plastic capable of moderate temperatures up to 250 such as polypropylene or similar material. While many designs could be chosen, the cone bottom tank with a stand is preferred. The preprocessor (20) is fitted to the top opening of the formulation chamber (10). The preprocessor (20) is generally designed to accept the solid chemical agent (12), but one skilled in the art can appreciate that the preprocessor (20) can be adapted to accept both solid chemical agent (12) and solvent (50) as shown in FIG. 3. While the solid chemical agent (12) can be added directly to the screen (46) without adverse effect, it is preferred that a dissolution tray (42) be placed substantially below the preprocessor (20). The screen (46) is typically positioned near the collector drain to capture un-dissolved solid chemical agent (12), generally larger than 1-2 cm, before entering the piping (14) system. Those skilled in the art can appreciate that the solid chemical agent (12) will eventually dissolve in the collector drain 48 during use.

The dissolution tray (42) can be seen as a premixing section, designed to hold solid chemical agent (12) in proximity with the dispenser (40) which supplies a fresh supply of solvent (50) or solvent plus formulation through the piping (14) system. The dispenser (40) can be seen as a delivery system for the solvent, and does not need to be a high pressure application. The dissolution tray (42) has been found to greatly accelerate the dissolving of the solid chemical agent (12). Further, a brim (44) can be located at the perimeter of the dissolution tray (42) to provide a section or area for mixing and dissolution. As the dissolution tray (42) fills with solution and solvent from a solvent source (50) and solid chemical agent (12), it creates a concentrated solution which drives toward saturation with the solid chemical agent (12) before flowing over the brim (44) toward the collector drain (48) forming a reservoir to mix the concentrated solution with the contents of the collector drain (48) which may comprise solvent with previous concentrations from the dissolution tray. A mechanical mixer, such as a stirring apparatus, beater, agitator, impeller, or the like, may be added to the dissolution tray (42) to further aid the mixing process.

A pump (56) is positioned with piping (14) to create hydraulic head necessary to move the formulation through the series of valves and piping. For example, a solvent valve (54a), controlled by a solvent valve controller (52a) can control the flow of solvent from the solvent source (50) into the system by means of piping (14); a re-circulating valve (54b) can control the affluent stream of formulation toward the heater element (60); and a feeder valve (54c) can control flow of the formulation to the applicator line (64), such as an aerosol generator.

Further, the series of valves can be coordinated by means of valve controls to aid in the control of the flow. These valve controls can be coordinated manually, or by use of electric or pneumatic switches, for example, and further controlled by a processor or computer as is common to the art.

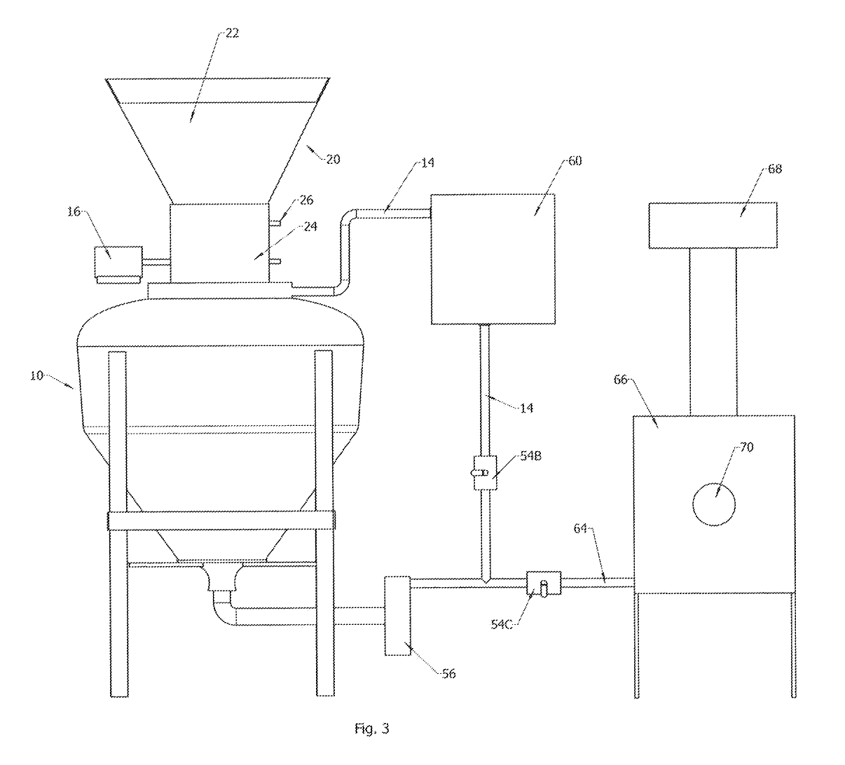

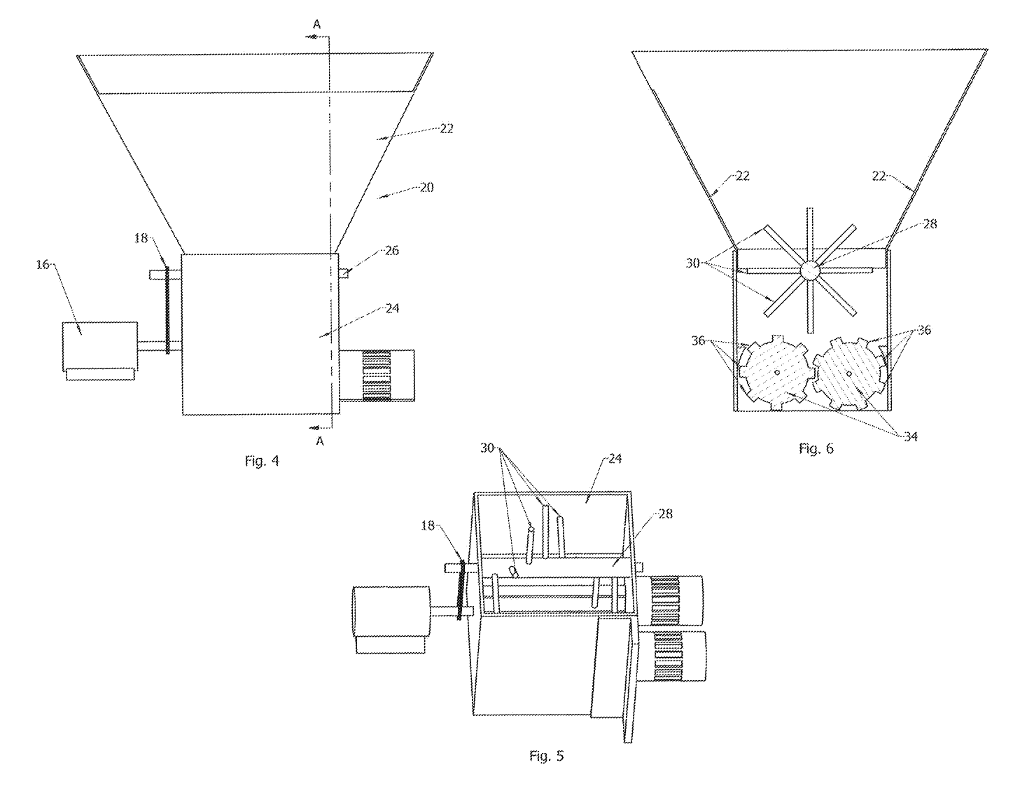

For example, at start up, a solid chemical agent (12), generally under ambient conditions, is added to a preprocessor (20) by way of a hopper (22), shown in FIGS. 4 through 6, typically in block form, and is ground to a desired consistency by means of a mill (24) which is typically driven by a motor (16) coupled with a drive mechanism (18). The mill (24) can further be comprised of a coarse mill (26) which may be comprised of a shaft (28) having a series of masticators (30) at predetermined positions along the shaft (28). The rotation of the coarse mill, can be designed to break-up a solid block to a consistency of about 6 to 8 cm. A fine mill which may be comprised of a series of wheels (34) generally having splines (36), or worm gears, or spurs, with a predetermined offset can then break up the solid chemical agent (12) further, to a consistency of about 2 to 5 mm, to aid in the dissolution process. It can be understood by one skilled in the art the advantages of this preferred method, and further that there are various equivalent means of accomplishing the task of preparing solid chemical agent (12) for dissolution. Further it is contemplated that the forgoing example is illustrative in nature and that any equivalent means are within the breadth of this disclosure. For example, the solvent source (50) may initially be added to the system by means of the preprocessor (20) as illustrated in FIG. 4. It is further anticipated that the consistency of solid chemical agent (12) exiting the mill (24) can vary as to the consistency and size of particles. This variation is also considered within the breadth of this disclosure. It is further anticipated that the preprocessor can be replaced with another means of providing starting material. This too is considered within the breadth of the present disclosure, and does not depart from the spirit of this invention.

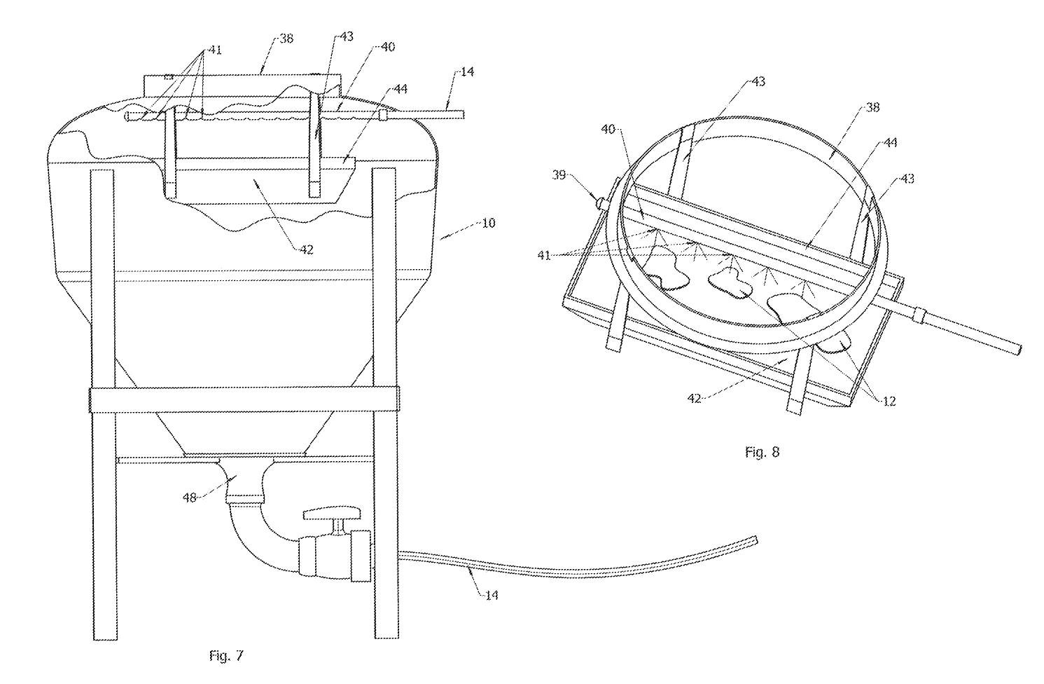

As the solid chemical agent (12) enters the formulation chamber (10) it is collected by means of a dissolution tray (42), which is positioned substantially below the crown (38) as shown in FIGS. 7 and 8. Either approximately before, during, or after the solid chemical agent (12) is added to the formulation chamber (10), the pump (56) is actuated with at least the re-circulating valve (54b) being opened to allow the flow of liquid through the piping (14) and to through a heater element (60) which controls the exit temperature of the formulation at a predetermined temperature as discussed above. The formulation in process is then directed by piping (14) to the dispenser (40) where it exits through ports (41) to further mix with, and dissolve, the solid chemical agent (12). To aid in the dissolution process and further contain the solid chemical agent (12), a brim (44), for creating a volume for mixing can be added to the dissolution tray (42). As the formulation reaches the brim (44) it spills over and is collected by the collector drain (48). A screen (46), which may be a shelf, filter, strainer, or similar device, may be positioned between the dissolution tray (42) and the collector drain (48) to filter small amounts of solid chemical agent (12) which may find their way toward the collector drain (48).

Once the characteristics of the formulation have reached the proper predetermined conditions, volume, temperature, formulation and the like; the feeder valve (54c) may be opened generally by means of the feeder valve controller (52c) to direct the desired volume of the formulation through an applicator line (64) to either an aerosol generator, or other applicator means. The re-circulating valve (54b) and the solvent valve (54a) may be positioned between opened and closed while the feeder valve (54c) is open in order to regulate the flow as desired. Typically the generation of formulation using the heated solvent is rapid enough that new formulation can be generated throughout the application process without interruption.

### CONCLUSION, RAMIFICATIONS, AND SCOPE

Although the present invention has been described in detail, those skilled in the art will understand that various changes, substitutions, and alterations herein may be made without departing from the spirit and scope of the invention in its broadest form. The fact that the primary embodiments centered around the treatment of potato sprouting, one skilled in the art can recognize that these methods can be used for preparing formulations for treating a number of agricultural products in a number of applications. The invention is not considered limited to examples chosen for purposes of disclosure, and covers all changes and modifications which do not constitute departures from the true spirit and scope of this invention.

Having thus described the invention, what is desired to be protected by Letters Patent is presented in the subsequent appended claims.

What is claimed is:

1. A process for creating chemical formulations for treating a produce storage facility comprising:
i.) providing a formulation chamber comprising a reservoir for collecting chemical formulations,
ii.) the reservoir having an initial solvent;
iii.) the formulation chamber further comprising a premixing section;
iv.) adding a solid chemical agent to the premixing section;
v.) circulating the solvent into the premixing section with the solid chemical agent to form a concentrated solution;
vi.) further mixing the concentrated solution with the contents of the reservoir to formulate a mixture.

2. The process in accordance with claim 1 wherein the solvent comprises at least one of; propylene glycol, or clove oil, or another suitable carrier base.

3. The process in accordance with claim 1 further comprising; re-circulating the mixture from the reservoir to the premixing section.

4. The process in accordance with claim 3, further comprising; heating the mixture to an elevated temperature during the re-circulation cycle.

5. The process in accordance with claim 4, wherein the temperature ranges between 80° F. and 200° F.

6. The process in accordance with claim 1, wherein the initial solvent comprises an initial concentration of solid chemical agent.

7. The process in accordance with claim 1, wherein the solid chemical agent comprises at least one of the group comprising: carbamate, and substituted naphthalene chemistries.

8. The process in accordance with claim 5, wherein the solid chemical agent comprises isopropyl-N-chlorophenylcarbamate (CIPC).

9. The process in accordance with claim 5, wherein the ratio of solvent to solute in the formulation ranges between 3% to 50% solvent by weight.

10. The process in accordance with claim 8

11. The process in accordance with claim 5, wherein the solid chemical agent comprises at least one of; powdered, pelletized, granular, or a block of at least one of the group consisting of carbamate, and substituted naphthalene chemistries.

12. The process in accordance with claim 7 further comprising; providing a grinding preprocessor for breaking up the solid chemical agent prior to mixing in the premixing section.

13. A method for treating produce in a storage facility comprising:
i.) providing a formulation chamber comprising a reservoir;
ii.) adding a solvent to the reservoir,
iii.) adding the solid chemical agent to the formulation chamber under ambient conditions to create a formulation,
iv.) providing a collector drain in the reservoir of the formulation chamber for collecting the formulation,
v.) providing a re-circulating system having a heater to heat the formulation collected from the collector drain and return it to the reservoir,
vi.) monitoring at least one of the temperature or the concentration of the formulation and, when predetermined conditions are met, channeling said solution toward an aerosol generator;
vii.) whereby said chemical agent can be applied as an aerosol to the storage facility.

14. A method for treating produce in accordance with claim 13 wherein; solid chemical agent is added to the formulation chamber as needed during application.

15. A method for treating produce in accordance with claim 14 wherein the solid chemical agent is provided in at least one of a; block, pellets, shavings, or other discrete form.

16. A method for treating produce in accordance with claim 15 wherein; the method further comprises providing a preprocessor for breaking up the solid chemical agent.

17. A method for treating produce in accordance with claim 16 wherein; the broken up solid is approximately 2 to 5 centimeters in size.

18. A method for treating produce in accordance with claim 13 wherein the reticulating system further comprises; a, screen, shelf, strainer, filter, or similar device, operatively between the dissolution tray and the collector drain for capturing un-dissolved portions of the solid chemical agent.

19. A method for treating produce in accordance with claim 13 wherein the heater to heat the formulation collected from the collector drain further comprises a tankless heater which supplies substantially instantaneous heating.
